(19) United States
(12) Patent Application Publication
(10) Pub. No.: US 2017/0046451 A1
(43) Pub. Date: Feb. 16, 2017

(54) Digital Representation Of Electronic Device

(71) Applicant: Apple Inc., Cupertino, CA (US)

(72) Inventors: Jody AKANA, San Francisco, CA (US); Bartley K ANDRE, Palo Alto, CA (US); Shota AOYAGI, San Francisco, CA (US); Anthony Michael ASHCROFT, San Francisco, CA (US); Jeremy BATAILLOU, San Francisco, CA (US); Daniel J. COSTER, San Francisco, CA (US); Daniele DE IULIIS, San Francisco, CA (US); M. Evans HANKEY, San Francisco, CA (US); Julian HOENIG, San Francisco, CA (US); Richard P. HOWARTH, San Francisco, CA (US); Jonathan P. IVE, San Francisco, CA (US); Duncan Robert KERR, San Francisco, CA (US); Marc A. NEWSON, London (GB); Matthew Dean ROHRBACH, San Francisco, CA (US); Peter RUSSELL-CLARKE, San Francisco, CA (US); Benjamin Andrew SHAFFER, San Jose, CA (US); Mikael SILVANTO, San Francisco, CA (US); Christopher J. STRINGER, Woodside, CA (US); Eugene Antony WHANG, San Francisco, CA (US); Rico ZÖRKENDÖRFER, San Francisco, CA (US)

(21) Appl. No.: 14/826,972

(22) Filed: Aug. 14, 2015

(51) Int. Cl. G06F 17/50

(52) U.S. Cl. CPC G06F 17/50

(57) ABSTRACT

A non-transitory computer-readable file is disclosed. In some embodiments, the file may include a digital representation of an electronic device, the digital representation having an ornamental design as shown in solid lines in FIGS. 1-9.

### FIELD

The described embodiments relate generally to electronic devices and parts therefor. More particularly, the present embodiments relate to computer files containing three-dimensional representations of electronic devices and parts therefor.

### BACKGROUND

Product design may be augmented by creating digital representations of three-dimensional objects. Often this is done on a computer using computer-aided design (CAD) software. The digital representations may be saved on a computer-readable medium as a computer-readable file.

Such computer-readable files may be accessed by a device with computational capacity. For example, a computer or a three-dimensional printer. Using the file, physical copies of the three-dimensional object represented in the computer-readable file can be made. For example, modern three-dimensional printers can receive the computer-readable file as input, and can output physical three-dimensional copies of the object represented in the computer-readable file.

### SUMMARY

Embodiments of the present invention include a non-transitory computer-readable file including a digital representation of an electronic device, the digital representation having an ornamental design as shown in solid lines in FIGS. 1-9.

### BRIEF DESCRIPTION OF THE DRAWINGS

The disclosure will be readily understood by the following detailed description in conjunction with the accompanying drawings, wherein like reference numerals designate like structural and/or ornamental elements.

FIG. 1 shows a front perspective view of an electronic device according to some embodiments.

FIG. 2 shows a rear perspective view thereof

FIG. 3 shows a front view thereof.

FIG. 4 shows a rear view thereof

FIG. 5 shows a left side view thereof.

FIG. 6 shows a right side view thereof.

FIG. 7 shows a top view thereof.

FIG. 8 shows a bottom view thereof

FIG. 9 shows a front perspective view thereof

FIG. 10 shows a schematic representation of a computer-readable medium according to some embodiments, and a computing device accessing it according to some embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Computer-readable files containing representations of three-dimensional objects may be created in many ways. For example, a designer can use CAD software to design a three-dimensional object as a digital three-dimensional representation. The physical object may then be produced by a reproduction method such as three-dimensional printing or other manufacturing method.

A counterfeiter may make a computer-readable file representing the same three-dimensional object or one similar thereto, by digitally recreating the three-dimensional object in a number of ways. For example, by using CAD software or a digital scanner to scan the physical item. Or he may otherwise obtain such a computer-readable file (e.g., by pilfering it from an original designer or other person, by being given it from another person, or by downloading it from a file storage medium (e.g., a file server or via a file sharing network)).

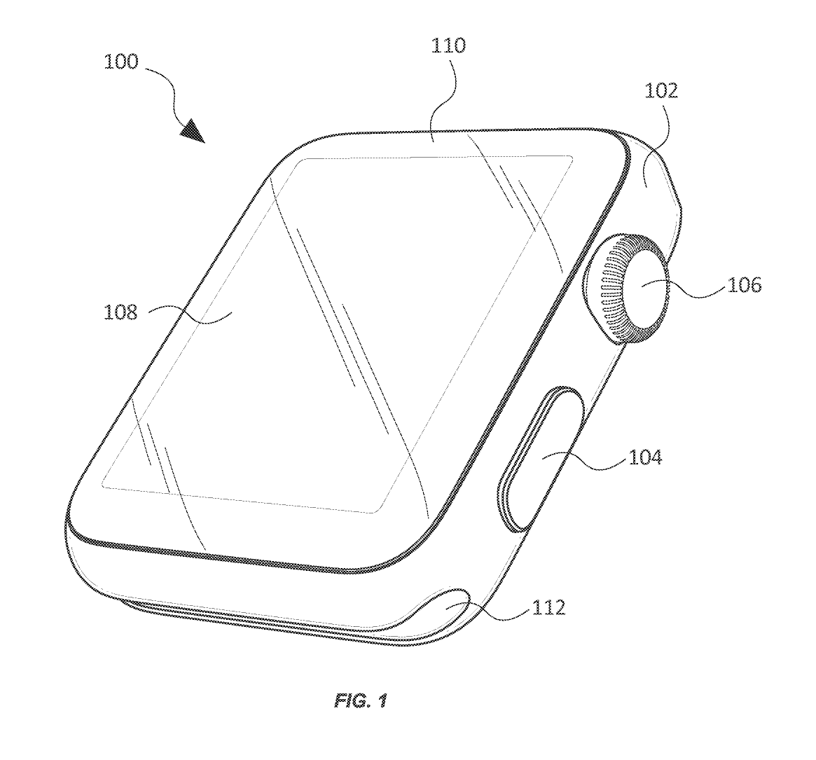

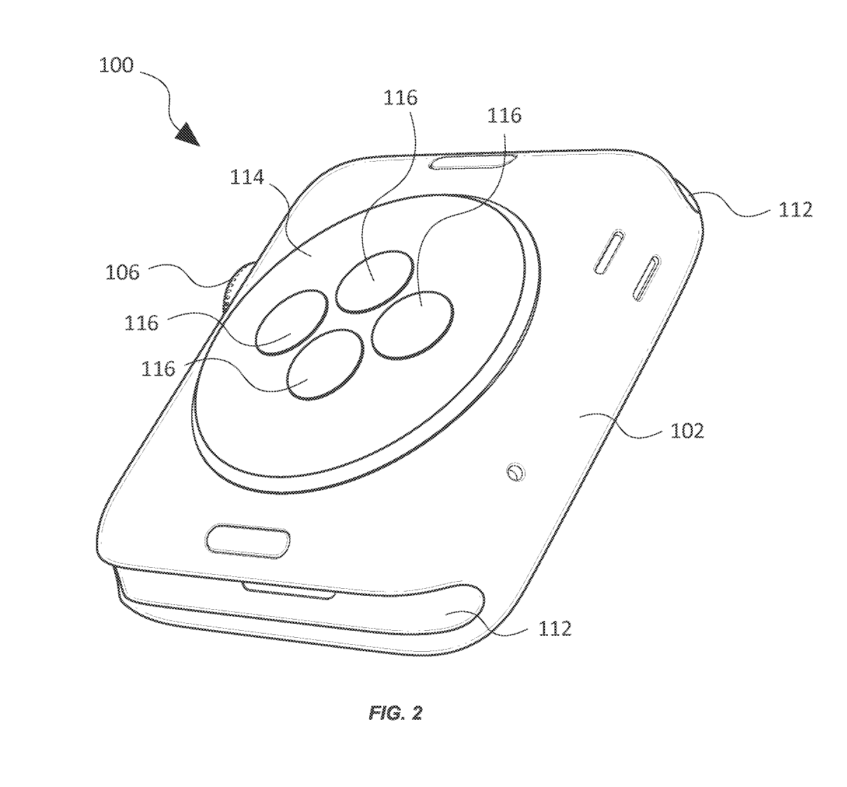

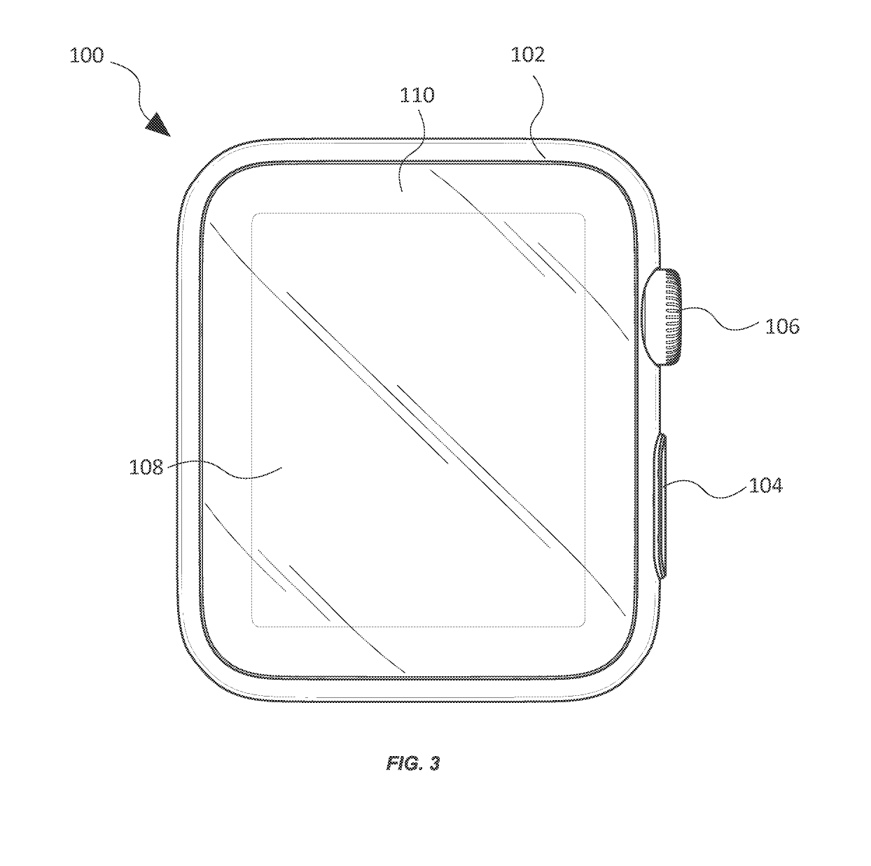

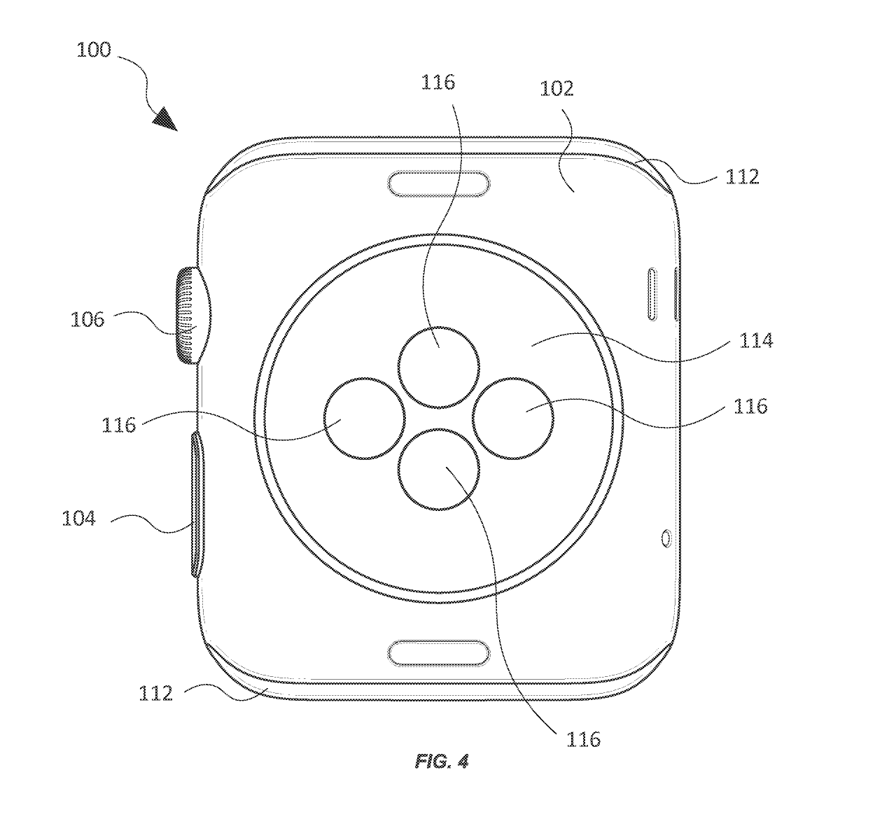

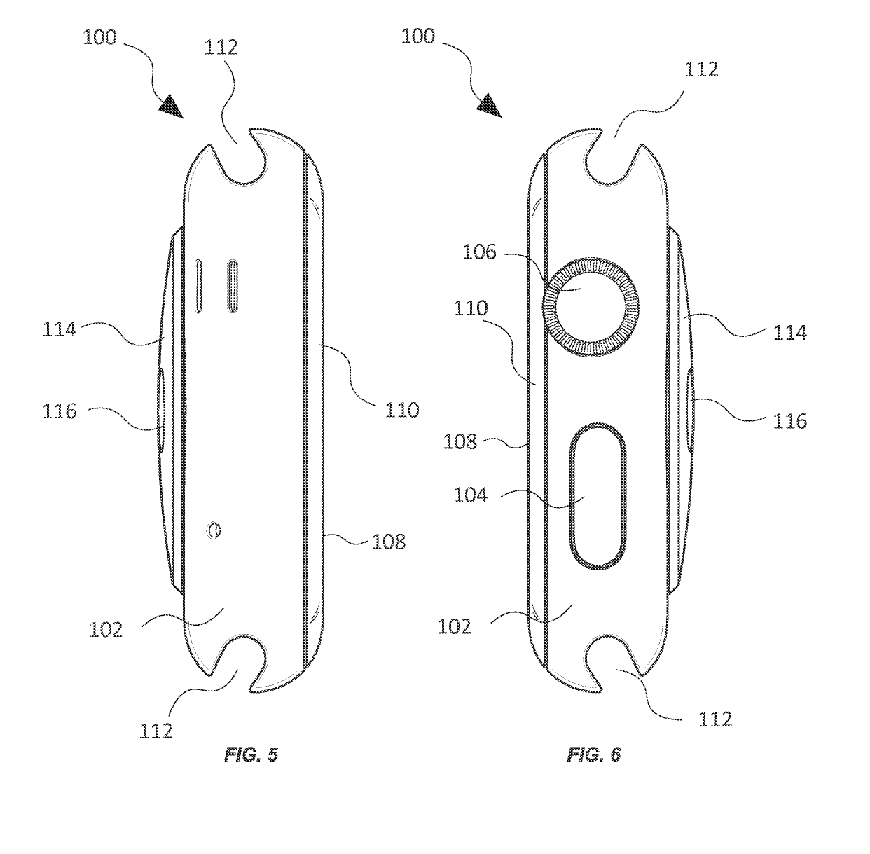

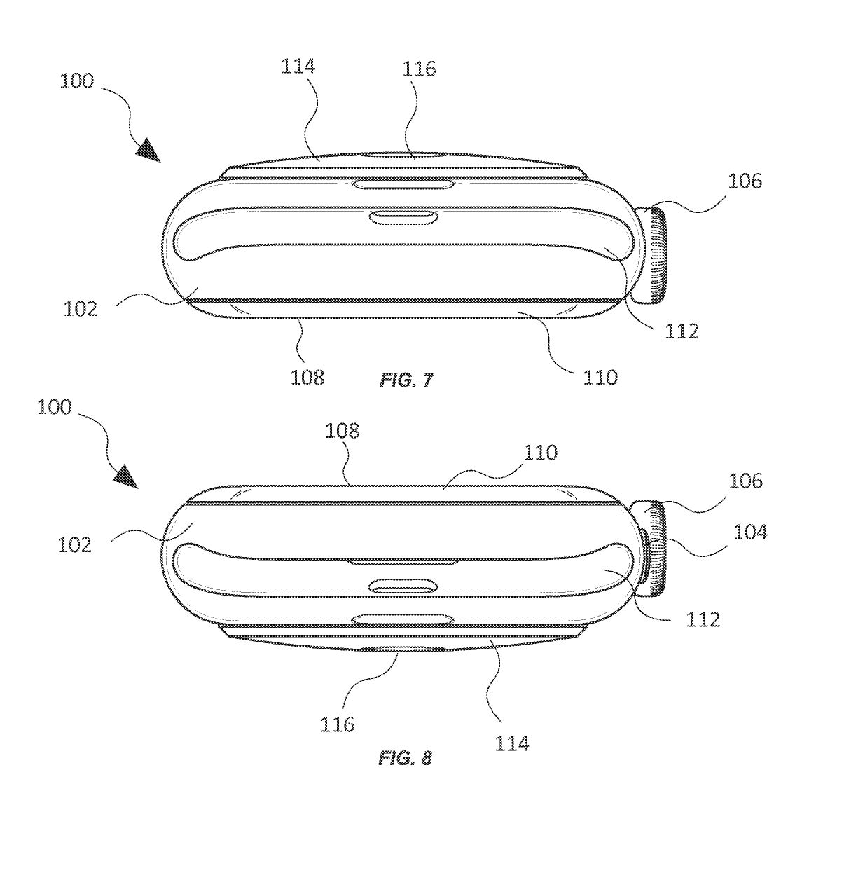

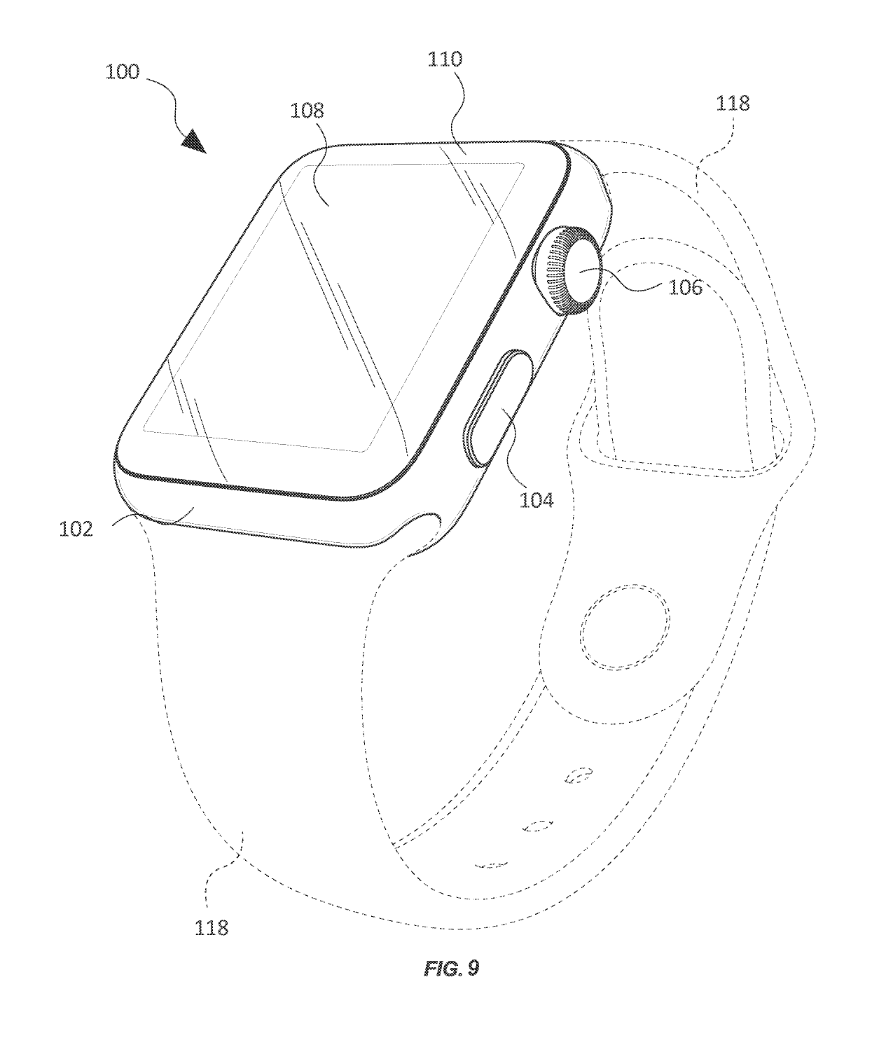

Some embodiments of the present invention include an electronic device or parts thereof, as shown in FIGS. 1-9. Some embodiments of the present invention include electronic devices or parts thereof that present identical or substantially similar overall appearances as those shown in FIGS. 1-9. Such embodiments may present an aesthetically appealing appearance, as they were intended to by their designers. Such appearance may help promote sales or use of the electronic device or parts thereof. Such appearance may present an aesthetic distinction from other electronic devices or parts thereof For example, the appearance of the electronic device or parts thereof of embodiments of the present invention may be an improvement over that of other electronic devices or parts thereof in the inventor's or others' estimation.

Some embodiments of the present invention include one or more digital representations 200 of the electronic device or parts thereof as shown in FIGS. 1-9. The electronic device may be, for example, a watch 100 (e.g., a smartwatch), having parts including a housing 102, button 104, crown 106, screen 108, mask 110, cavities for receiving bands 112, rear panel 114 with surface features 116, bands 118 and other features as shown in FIGS. 1-9. Embodiments of the present invention may include all of these parts together, or any subset or combination of them, including portions thereof

Some embodiments of the present invention include a non-transitory computer-readable medium 300 storing a digital representation 200 of electronic device 100 or parts thereof (which may include all parts together, or any subset or combination of them, including portions thereof, as described above). Digital representation 200 may be non-transitorily stored on computer-readable medium 300. For example, digital representation 200 may be stored on computer-readable medium 300 as a computer-readable file 210 stored on computer-readable medium 300.

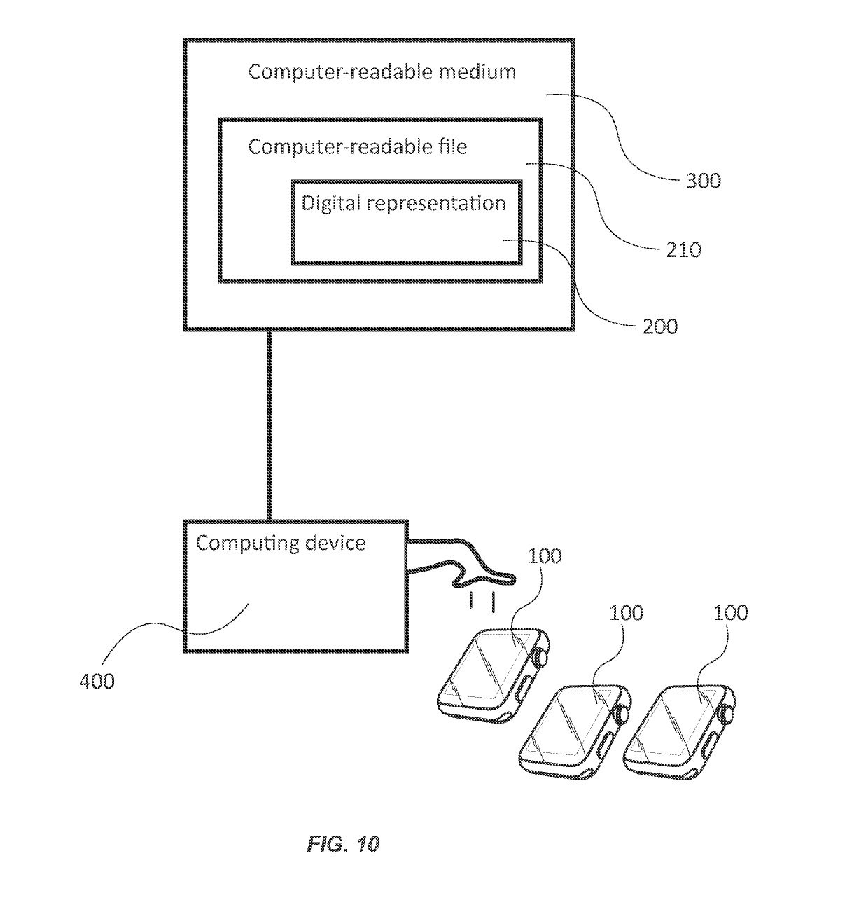

In some embodiments, computer-readable file 210 (or computer-readable medium 300 storing it) may be accessed and/or executed by a computing device 400 (i.e., a device including a processor, the device having computational capacity (e.g., a computer or a three-dimensional printer). Computing device 400 may, in response to such access and/or execution of computer-readable file 210, access digital representation 200 of electronic device 100 or parts thereof Digital representation 200 may then be used by computing device 400 (alone or in conjunction with other computing devices) for any number of purposes, for example, physically producing the digitally-rendered object represented in digital representation 200 (e.g., electronic device 100 or parts thereof). See FIG. 10.

In some embodiments, computer-readable storage medium 300 may be embodied in a single physical storage medium or unit, such as, for example, a hard drive, random access memory (RAM), a read-only or rewritable optical disc (e.g., compact disc read-only memory (CD-ROM), compact disc rewritable (CD-RW), and digital video disc (DVD)), a floppy disc, a floptical disc, a magnetic storage device (e.g., magnetic disc or tape) a solid-state memory device, a semiconductor memory device, and various other storage mediums and units that would be apparent to one of skill in the art.

In some embodiments, computer-readable storage medium 300 may be embodied in multiple separate storage mediums, which may or may not be of the same type. The separate storage mediums can all be a part of one cohesive system, connected to one another and to an access unit, such as a computer. Such connection can be by wires, wirelessly, or both. In some embodiments the separate storage units can be connected to various distinct systems, which may or may not be located remotely from one another. In such a case, the separate storage units can be connected to one another and at least one access unit via a network, such as an intranet or the Internet.

In some embodiments, an access unit used to access computer-readable storage medium 300 is directly connected to computer-readable storage medium 300 (e.g., via wires or wirelessly). In some embodiments, an access unit to access computer-readable storage medium 300 is located remotely from computer-readable storage medium 300 and connects to computer-readable storage medium 300 via, for example, a network, such as an intranet or the Internet.

In the figures, portions of the electronic device or parts thereof may be drawn in dashed broken lines. This is to help clarify the claim scope where the claims refer to the drawings. For example, as may be described in the claims, a portion shown in solid lines may represent a claimed portion, and a portion shown in dashed broken lines may represent a portion that is not claimed.

Also for example, a portion shown in dot-dash broken lines may represent boundaries (e.g., of claimed portions), where the dot-dash-broken-line boundaries themselves are not claimed.

Shade lines may be used in the Figures to show contour or to represent transparency, reflectiveness, or translucency. Such shade lines are not surface ornamentation.

Since embodiments of the present invention may include all of the disclosed features of the electronic device together, or any subset or combination of them, any solid line in the figures may by amendment be replaced with a broken line, and any broken line may be replaced with a solid line, to help clarify or change claim scope. Since such embodiments are contemplated by the inventors and explicitly described here, changes to effect them by, for example, changing any solid line to a broken line, or changing any broken line to a solid line, are not new matter.

In some embodiments, digital representations of the electronic device described herein have an ornamental appearance as shown in the Figures if, in the eye of an ordinary observer, giving such attention as a purchaser usually gives, the design of the digital representation is substantially the same as the design shown in the Figures.

What is claimed is:

1. A non-transitory computer-readable file that when executed produces a digital representation of an article as shown in solid lines in at least one of FIGS. 1-9.

2. The non-transitory computer-readable file of claim 1, wherein when executed the computer-readable file produces a digital representation of an article as shown in solid lines in all of FIGS. 1-9.

3. The non-transitory computer-readable file of claim 1, wherein when executed the computer-readable file produces a three-dimensional digital representation of an article as shown in solid lines in FIGS. 1-9.

4. A non-transitory computer-readable file comprising a digital representation of an electronic device, the digital representation having an ornamental design as shown in solid lines in FIGS. 1-9.

5. A non-transitory computer-readable medium comprising the non-transitory computer-readable file of claim 4.

6. The non-transitory computer-readable file of claim 4, wherein the digital representation has a substantially similar overall appearance to the ornamental design as shown in solid lines in FIGS. 1-9.

7. The non-transitory computer-readable file of claim 4, wherein the digital representation is a three-dimensional representation.

8. The non-transitory computer-readable file of claim 4, wherein the digital representation is a three-dimensional digital reproduction having a substantially similar overall appearance to the ornamental design as shown in solid lines in FIGS. 1-9.
